(19) United States
(12) Patent Application Publication
(10) Pub. No.: US 2015/0031378 A1
(43) Pub. Date: Jan. 29, 2015

(54) METHOD FOR PERFORMING CONNECTION MANAGEMENT IN A MOBILE COMMUNICATION NETWORK, USER TERMINAL AND BASE STATION

(71) Applicant: NEC Europe Ltd., Heidelberg (DE)

(72) Inventors: Peter Rost, Heidelberg (DE); Andreas Maeder, Heidelberg (DE)

(21) Appl. No.: 14/384,971

(22) PCT Filed: Mar. 18, 2013
(86) PCT No.: PCT/EP2013/055528

§ 371 Date: Sep. 12, 2014

(30) Foreign Application Priority Data
Mar. 16, 2012 (EP) 12159902.1

(51) Int. Cl. H04W 76/04; H04W 76/06

(52) U.S. Cl. CPC H04W 76/045; H04W 76/066
USPC 455/450

(57) ABSTRACT

A method for performing connection management in a mobile communication network, wherein the network comprises one or more base stations and at least one user terminal being connected to any of said one or more base stations is characterized in that the user terminal provides information which informs the base station the user terminal is connected to that no data transmission from the user terminal to said base station is expected within a certain time interval Tₑₓₚ.

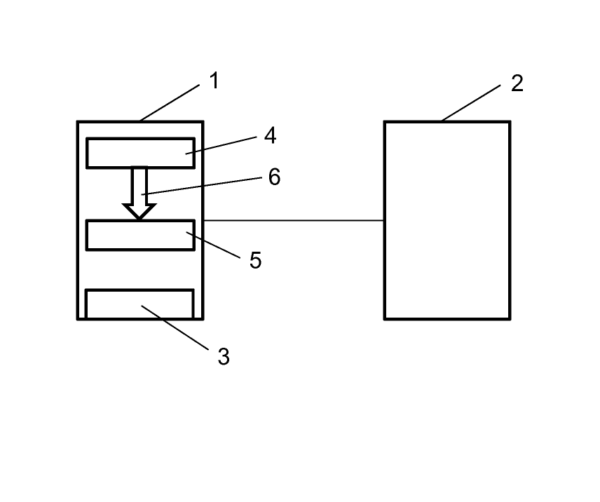

The present invention relates to a method for performing connection management in a mobile communication network, wherein the network comprises one or more base stations and at least one user terminal being connected to any of said one or more base stations.

Furthermore, the present invention relates to a user terminal for deployment in a mobile communication system, wherein the user terminal is enabled to connect to a base station of said mobile communication system.

Still further, the present invention relates to a base station for deployment in a mobile communication system.

In cellular networks connection and resource management is a crucial task. Generally, in cellular mobile communication systems, communication between user terminals and base stations is connection oriented. A connection is usually first requested by the user terminal, then confirmed by the base station and then further radio resource control information is exchanged in order to set up the connection. Once the connection is established, the user terminal and the base station exchange signaling messages quasi continuously.

Consider the following example: a user terminal runs a background process which sporadically generates packets of very limited size. In order to communicate this data to the cellular network, the terminal has to set up a connection to a base station. Using 3GPP LTE as an example, this includes the transmission of a Preamble (UE→eNB), Random Access Response (eNB→UE), Connection Request (UE→eNB), and Connection Setup (eNB→UE). Afterwards both parties exchange additional RRC messages, e.g. to indicate the buffer status or to reconfigure the radio bearer. Additionally, messages are exchanged with network entities in the core network for various means such as authentication and core network connection management.

The above scenario exemplifies that even low data volumes imply significant overhead for the connection management of wireless networks. Further examples include instant messaging where only a few bytes are exchanged in intervals of multiple seconds or even minutes, or machine-to-machine communication where terminals regularly and autonomously report to a central entity.

Even during a period of inactivity, the terminal may still occupy physical radio resources as well as management resources at the base station. The user terminal occupies these resources during the time interval T_{inactive} from the last transmitted packet until the network detects that the user terminal does not require any further resources, which therefore can be released for other connections. Furthermore, during time interval T_{inactive} the user terminal should not turn off its radio frontend in order to receive downlink control messages. Hence, during time interval T_{inactive} the user terminal consumes unnecessarily energy. A cellular communication network, in general, aims to reduce the number of unnecessarily occupied physical radio resources as these resources are limited. For example, in 3GPP LTE one physical resource block may carry 18 scheduling requests or 12 CQI reports. This may easily be exceeded given the growing number of mobile terminal users.

It is therefore an object of the present invention to improve and further develop a method for performing connection management in a mobile communication network and a user terminal as well as a base station for deployment in a mobile communication system of the initially described type in such a way that the overhead in the connection management is significantly reduced.

In accordance with the invention, the aforementioned object is accomplished by a method comprising the features of claim 1. According to this claim such a method is characterized in that the user terminal provides information which informs the base station the user terminal is connected to that no data transmission from the user terminal to said base station is expected within a certain time interval Tₑₓₚ.

Furthermore, the aforementioned object is accomplished by a user terminal comprising the features of independent claim 14. According to this claim, such a user terminal is characterised in that it is configured to provide information which informs the base station the user terminal is connected to that no data transmission from the user terminal to the base station is expected within a certain time interval.

Still further, the aforementioned object is accomplished by a base station comprising the features of independent claim 23. According to this claim, such a user terminal is characterised in that it is configured to receive information from a connected user terminal which informs the base station that no data transmission from the user terminal to the base station is expected within a certain time interval.

According to the invention it has been recognized that the efficiency of connection and resource management in mobile cellular networks can be significantly improved by signaling application traffic information from user terminals to their base stations. Specifically, the user terminals provide information to a base station that within a certain time interval no further data transmission is expected. This information can be exploited by the base station to improve the resource efficiency.

While there are almost no performance gains for user terminals with high traffic volume and low inactivity periods, the present invention is particularly useful for performing connection and resource release processes for applications which generate a very limited amount of data, e.g. instant message services or operating system background traffic. For such traffic with low data volume and high inactivity times, the present invention enables fast connection release. Applying embodiments of the invention in connection with user terminals that generate, at least temporarily, a limited amount of data results in a reduced overhead for connection management and, in particular, for connection release procedures. For inactive user terminals the present invention in enables a reduced physical layer overhead.

As will be appreciated by those skilled in the art, the information regarding a certain time interval in which a user terminal expects no data transmissions to its connected base station, is not limited to a single time interval, but may include multiple such time intervals.

According to a preferred embodiment the information may be provided to the base station by integrating the information into a buffer status report that is exchanged between the user terminal and the base station. For instance, in 3GPP LTE, the buffer status report (BSR) is a MAC message exchanged between UE and eNB, as described in 3GPP TS 36.321: “3rd Generation Partnership Project, Technical Specification Group Radio Access Network; Evolved Universal Terrestrial Radio Access (E-UTRA); Medium Access Control (MAC) protocol specification”. Specifically, the BSR may carry the additional information regarding the expected time interval Tₑₓₚ in which no data transmission from the user terminal to the base station is expected either in an additional field descriptor or by changing the format of the BSR.

Alternatively, a separate MAC control entity may be introduced in the network, which explicitly informs the base station about the time-interval Tₑₓₚ in which no further data transmission is expected. The corresponding messages may be sent periodically or after the user terminal knows that within a certain time interval Tₑₓₚ no further data transmission is expected.

According to another alternative embodiment, the information may be provided to the base station by means of a dedicated radio resource control (RRC) message.

Upon receiving the information at the base station, it may be provided that the base station may use the information to start releasing physical radio resources and/or radio resource management (RRM) resources at the base station itself. Alternatively, upon receiving the information, the base station may start initiating a connection release of the user terminal.

In order to be able to provide the information that within time-interval Tₑₓₚ no further transmissions from a user terminal to the base station are expected, the user terminal first needs to reliably determine whether within time-interval Tₑₓₚ any data transmission activities are expected. According to one embodiment this test may be performed by the user terminal's operating system. More specifically, the operating system of a user terminal typically generates background traffic. Therefore, the operating system, which also runs the mobile communication software itself, is able to appropriately inform the mobile communication software, e.g. by means of an application programming interface (API), whether for the particular connection that carries the background traffic, no further data is expected within time-interval Tₑₓₚ.

According to another preferred embodiment the user terminal may comprise an analyzing tool for performing an inspection of data that is supposed to be transmitted and for identifying the service and/or application that generated the data. For instance, the user terminal's analyzing tool may be configured to perform a kind of “deep packet inspection” with respect to the data that is supposed to be transmitted. This allows the user terminal to acquire additional knowledge about the actual service or application that generated the data. Using knowledge about the service itself may then allow the user terminal to determine whether with a certain probability within time interval Tₑₓₚ another data transmission will be performed. The knowledge that is applied to determine the application and Tₑₓₚ may be acquired through statistics that are collected over a past period of time or may be available through a lightweight database that has been provided to the user terminal. For instance, in case of instant messaging applications such as Skype and WhatsApp, the user terminal may be configured to detect that a certain data packet belongs to this service class (e.g., by inspecting the TCP port and IP addresses). Based on the service/application specific knowledge acquired by the user terminal as described above, it may infer that within a certain time-interval Tₑₓₚ with a certain probability no further data transmissions will be performed.

According to another preferred embodiment the user terminal may be configured to identify a service and/or application established with another node based on the other node's target address. For instance, in an IP-based system, the user-terminal may reliably identify a service based on the IP-address, which may allow the user terminal to infer the probability of a data transmission within time-interval Tₑₓₚ. Examples for such a service are instant messaging applications where the IP-address of the assigned server for the instant message service is known to the user terminal, or if the user-terminal sends reports to the network of a mobile network operator the address and therefore frequency of activity may be known.

According to another preferred embodiment the user terminal may be configured to provide only a limited number of services and/or applications for which the statistics about Tₑₓₚ are known a-priori. For instance, in machine-to-machine communication user terminals may provide services with known traffic characteristics and even deterministically known time-intervals between data transmissions. In such a case, the user terminal can reliably inform its associated base station that within time-interval Tₑₓₚ no further data transmission is expected.

According to another preferred embodiment the user terminal may comprise an application programming interface (API) in order to provide the possibility that a service and/or a application inform directly the protocol stack that within time-interval Tₑₓₚ no further data transmission is expected.

According to still another preferred embodiment the user terminal may be configured to exploit knowledge about data transmission schedules which imply a deterministic behavior such that periodically data transmissions with a certain amount of data are performed. Examples of such schedules are regular operating system messages which request updates or provide information to the mobile network.

The length of the time-interval Tₑₓₚ, which is used as a basis to perform the indication whether a data-transmission will be performed, may be specified according to different procedures. For instance, according to a straightforward embodiment that can be easily implemented and that yields high reliability the time-interval Tₑₓₚ may be standardized and pre-provisioned for a mobile communication network. Hence, it is known to all user terminals connected to the network and no further configuration is required.

According to another preferred embodiment the length of the time-interval Tₑₓₚ may be derived directly from the configuration and parameterization of the mobile communication network. Therefore, the time-interval can be flexibly defined and optimized for different mobile communication networks. The derivation of time-interval Tₑₓₚ must be known to the user terminal and the base station. The derivation of time-interval Tₑₓₚ may be standardized.

With respect to enhanced flexibility it may be provided that the time-interval Tₑₓₚ is configured individually per cell of the mobile communication network. To inform connected user terminals effectively, the corresponding configuration may be included in a broadcast message transmitted by the base station. With respect to still further enhanced flexibility it may be provided that the time-interval Tₑₓₚ is configured per user terminal, e.g. by using separate configuration elements in the radio connection setup procedure. In addition, it may be provided that the time interval Tₑₓₚ is re-configured per user terminal using separate configuration elements in the radio connection re-configuration procedure.

According to another preferred embodiment the time interval Tₑₓₚ may be defined by derivation from existing timers or other time-related constants related to the user terminal. As a particular example for 3GPP LTE, the time alignment timer (TAT) may serve as timer and the user terminal may use the TAT or a multiple of the TAT as basis for the length of the time-interval Tₑₓₚ. The advantage of directly relating time interval Tₑₓₚ and TAT is the avoidance of an unnecessary re-synchronization.

According to another preferred embodiment the time interval Tₑₓₚ may be defined and/or signaled by the user terminal with each report in which the information, whether within time interval Tₑₓₚ a data transmission is expected or not, is transmitted to the base station. Alternatively, the time interval Tₑₓₚ may be defined and/or signaled by the user terminal during the radio connection setup procedure or by using the radio connection reconfiguration procedure.

There are several ways how to design and further develop the teaching of the present invention in an advantageous way. To this end, it is to be referred to the patent claims subordinate to patent claims 1, 14 and 23 on the one hand, and to the following explanation of a preferred example of an embodiment of the invention illustrated by the drawing on the other hand. In connection with the explanation of the preferred example of an embodiment of the invention by the aid of the drawing, generally preferred embodiments and further developments of the teaching will be explained. In the drawings the only

FIGURE is a schematic illustration of a base station and a connected user terminal in a cellular network in according with an embodiment of the present invention.

Even though the scenarios described hereinafter are related to 3GPP LTE, it will be appreciated by those skilled in the art that the present invention is not limited to 3GPP LTE, but can be applied in connection with different kinds of cellular networks that operate according to other standards than 3GPP LTE.

The following description explains how connections and resources are managed in currently operating cellular networks and exemplifies this based on 3GPP LTE. Table 1 shows a typical connection establishment and release, as specified in 3GPP LTE R10 (see for reference 3GPP TR 36.922: “3rd Generation Partnership Project; Technical Specification Group Radio Access Network; LTE RAN Enhancements for Diverse Data Applications”):

| | ↑ | | | |
|---|---|---|---|---|
| | UL | | MAC PDU | |
| | ↓ | Contents (of MAC PDU or L1 | Size (Bytes) | |
| Step | DL | control) | UL | DL |
| 1 | ↑ | Preamble | — | — |
| 2 | ↓ | Random Access Response | — | 8 |
| | | (+PDCCH DL grant) | | |
| 3 | ↑ | RRC Connection Request | 7 | — |
| 4 | ↓ | PHICH ACK | — | — |
| 5 | ↓ | Contention Resolution CE | — | 7 |
| | | (+PDCCH DL grant) | | |
| 6 | ↑ | PUCCH ACK | — | — |
| 7 | ↓ | RRC Connection Setup (+PDCCH | — | 30 |
| | | DL grant) | | |
| 8 | ↑ | PUCCH ACK | — | — |
| 9 | ↑ | Scheduling Request | — | — |
| 10 | ↓ | PDCCH UL grant | — | — |
| 11 | ↑ | RRC Connection Setup Complete | 20 | — |
| | | (inc. NAS Service Request) + PHR + | | |
| | | short BSR | | |
| 12 | ↓ | PHICH ACK | — | — |
| 13 | ↓ | RLC Status PDU (+PDCCH DL | — | 3 |
| | | grant) | | |
| 14 | ↑ | PUCCH ACK | — | — |
| 15 | ↓ | Security Mode Command (+PDCCH | — | 11 |
| | | DL grant) | | |
| 16 | ↑ | PUCCH ACK | — | — |
| 17 | ↑ | Scheduling Request | — | — |
| 18 | ↓ | PDCCH UL grant | — | — |
| 19 | ↑ | Security Mode Complete + RLC | 17 | — |
| | | Status PDU + PHR + short BSR | | |
| 20 | ↓ | PHICH ACK | — | — |
| 21 | ↓ | RLC Status PDU (+PDCCH DL | — | 3 |
| | | grant) | | |
| 22 | ↑ | PUCCH ACK | — | — |
| 23 | ↓ | RRC Connection Reconfiguration | — | 45 |
| | | (+PDCCH DL grant) | | |
| 24 | ↑ | PUCCH ACK | — | — |
| 25 | ↑ | Scheduling Request | — | — |
| 26 | ↓ | PDCCH UL grant | — | — |
| 27 | ↑ | RRC Connection Reconfiguration | 19 | — |
| | | Complete + RLC Status PDU + PHR + | | |
| | | short BSR | | |
| 28 | ↓ | PHICH ACK | — | — |
| 29 | ↓ | RLC Status PDU (+PDCCH DL | — | 3 |
| | | grant) | | |
| 30 | ↑ | PUCCH ACK | — | — |
| 31 | ↓ | RRC Connection Release | — | 10 |
| | | (+PDCCH DL grant) | | |
| 32 | ↑ | PUCCH ACK | — | — |
| 33 | ↑ | Scheduling Request | — | — |
| 34 | ↓ | PDCCH UL grant | — | — |
| 35 | ↑ | RLC Status PDU | 3 | — |
| 36 | ↓ | PHICH ACK | — | — |

| | | |
|---|---|---|
| Total Bytes | 66 | 120 |
| Number of occupied subframes | 18 | 18 |

In cellular mobile communication systems, communication between user terminals and base stations is connection oriented. A connection is usually first requested by the user terminal, then confirmed by the base station and then further radio resource control information is exchanged in order to set up the connection. According to the 3GPP LTE R10 example given in the table above, a user terminal (UE) indicates with the transmission of a RRCConnectionRequest message that it requests to setup a logical RRC connection. This is answered by the base station, denoted eNB hereinafter, with a RRCConnectionSetup message, which defines the connection setup and which is confirmed by the user terminal, denoted UE hereinafter, with a RRCConnectionSetupComplete message. The RRCConnectionSetup message contains information on signaling and data radio bearers (SRB and DRB) which are defined in detail by the RadioResourceConfigDedicated field. After reception of this message, a logical Dedicated Control Channel (DCCH) and Dedicated Traffic Channel (DTCH) are established. Afterwards the security mode is configured (SecurityModeCommand and SecurityModeComplete), and possibly the connection is reconfigured. After completion of this process, the UE may transmit data.

The UE submits for both the DCCH and DTCH buffer status reports indicating the amount of data ready for transmission. This may be done in the same TTI as RRCConnectionSetupComplete, SecurityModeComplete, and

RRCConnectionReconfigurationComplete. This information is exploited by the eNB to perform uplink scheduling of all assigned user terminals.

In addition, OFDM-based cellular networks operate synchronously in order to minimize inter-symbol interference. In order to maintain synchronization, regular uplink transmissions are necessary such that the base station can estimate the timing advance value for the uplink transmissions. If the required resources for these regular transmissions exceed the overhead to re-synchronize a user terminal after a given time interval in which no further data is transmitted, it may be preferable to not maintain synchronization but rather release resources and re-synchronize the user terminal.

A connection release in cellular mobile networks may be triggered for various reasons, e.g. due to inactivity of the user after a certain time-interval, due to user-request, or for overload control (congestion control). However, if a connection-release is initiated after a certain time-interval T-inactive of user inactivity, the system still has to reserve radio and management resources for this user terminal during time interval T_{inactive}. In 3GPP LTE R10 this implies, that user terminals may still regularly provide measurement reports, maintain synchronization and occupy reserved uplink control channel (PUCCH) resources for scheduling requests (SRs).

Alternatively, the user terminal may directly indicate that it requests to close a connection. However, this implies significant control signaling overhead. In 3GPP LTE R10, a UE may initiate a detach-procedure (as specified in 3GPP TS 24.301: “3rd Generation Partnership Project; Technical Specification Group Core Network and Terminals; Non-Access-Stratum (NAS) protocol for Evolved Packet System (EPS); Stage 3”) by directly communicating with the non-access stratum (NAS), in particular, the mobility management entity (MME).

The only FIGURE schematically illustrates an embodiment of the present invention. In a cellular network, user terminal 1 is connected to a base station 2. The user terminal 1 includes at least a radio frontend 3 for physically transmitting/receiving messages to/from base station 2, and an operating system 4, which runs the mobile communication software 5.

It is assumed that user terminal 1 runs a background process that sporadically generates packets of very limited size that are communicated to the cellular network via the user terminal's 1 connection set up to base station 2. In accordance with an embodiment of the present invention, the operating system 4 of the user terminal 1, which generates background traffic related to the background process, appropriately informs the mobile communication software 5 by means of an application programming interface 6 (API), whether for the particular connection, which carries the background traffic, no further data is expected within time-interval Tₑₓₚ (or multiple such intervals). Via the user terminal's 1 radio frontend 3 this information is transmitted to base station 2. In order to provide the information whether within a certain time-interval no further data transmission is expected, information about the specific application and/or service running on the user terminal 1 may be exploited to determine the time-interval. In accordance with the invention, the base station 2 uses the information to release physical radio resources as well as RRM resources at the base station 2 itself. Alternatively, the base station 2 may initiate a release of the user terminal's 1 connection based on the provided information.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for performing connection management in a mobile communication network, wherein the network comprises
one or more base stations (2) and
at least one user terminal (1) being connected to any of said one or more base stations (2),
wherein the user terminal (1) provides information, that informs the base station (2) to which the user terminal (1) is connected, that no data transmission from the user terminal (1) to said base station (2) is expected within a certain time interval Tₑₓₚ.

2. (canceled)

3. (canceled)

4. (canceled)

5. Method according to claim 1, wherein said base station (2), upon receiving said information, starts releasing physical radio resources and/or radio resource management resources.

6. Method according to claim 1, wherein said base station (2), upon receiving said information, starts initiates a connection release of said user terminal (1).

7. (canceled)

8. (canceled)

9. (canceled)

10. (canceled)

11. (canceled)

12. (canceled)

13. (canceled)

14. User terminal for deployment in a mobile communication system, wherein the user terminal (1) is enabled to connect to a base station (2) of said mobile communication system,
wherein the user terminal (1) is configured to provide information, that informs the base station (2) to which the user terminal (1) is connected to, that no data transmission from the user terminal (1) to the base station (2) is expected within a certain time interval Tₑₓₚ.

15. User terminal according to claim 14, further comprising a MAC control entity that is configured to transmit said information to said base station (2).

16. User terminal according to claim 14, wherein the user terminal's (1) operating system (4) is configured to inform the user terminal's mobile communication software (5) if no data is expected for a particular connection within a certain time interval Tₑₓₚ.

17. User terminal according to claim 14, further comprising an analyzing tool for performing an inspection of data that is supposed to be transmitted and for identifying the service and/or application that generated the data.

18. User terminal according to claim 17, further comprising a database for retrieving knowledge about the identified service and/or application.

19. User terminal according to claim 14, being configured to identify a service and/or application established with another node based on said other node's target address.

20. User terminal according to claim 14, being configured to support only a limited number of services and/or applications with well-known traffic characteristics.

21. User terminal according to claim 14, further comprising an application programming interface being configured to be used by a service and/or application running on said user terminal (1) to provide said information directly to the protocol stack.

22. User terminal according to claim 14, being configured to exploit knowledge about data transmission schedules having a deterministic behavior.

23. Base station for deployment in a mobile communication system, wherein the base station (2) is configured to receive information from a connected user terminal (1) which informs the base station (2) that no data transmission from the user terminal (1) to the base station (2) is expected within a certain time interval Tₑₓₚ.

24. Base station according to claim 23, being configured, upon receiving said information, to start releasing physical radio resources and/or radio resource management resources.

25. Base station according to claim 23, being configured, upon receiving said information, to start initiating a connection release of said user terminal (1).

26. Method according to claim 1, wherein said time interval Tₑₓₚ is configured individually for each cell of said mobile communication network.

27. Method according to claim 1, wherein said information is provided to said base station (2) by integrating said information into the buffer status report that is exchanged between said user terminal (1) and said base station (2) within a MAC message.

28. Method according to claim 1, wherein said information is provided to said base station (2) by a separate MAC control entity.

29. Method according to claim 1, wherein said information is provided to said base station (2) by means of a dedicated radio resource control message.

30. Method according to claim 1, wherein said time interval Tₑₓₚ is re-configured per user terminal (1) using separate configuration elements in the radio connection re-configuration procedure.
